(19) United States
(12) Patent Application Publication
(10) Pub. No.: US 2026/0031508 A1
(43) Pub. Date: Jan. 29, 2026

(54) BATTERY AND METHOD OF MANUFACTURING THE SAME

(71) Applicant: SAMSUNG SDI CO., LTD., Yongin-si (KR)

(72) Inventor: TAEWOONG JANG, Yongin-si (KR)

(21) Appl. No.: 18/967,930

(22) Filed: Dec. 4, 2024

(30) Foreign Application Priority Data
Jul. 23, 2024 (KR) 10-2024-0097132

(51) Int. Cl. H01M 50/538; H01M 50/171

(52) U.S. Cl. CPC H01M 50/538; H01M 50/171

(57) ABSTRACT

A battery, including an electrode assembly including a first electrode plate to which a first electrode tab is connected, a second electrode plate to which a second electrode tab is connected, and a separator interposed between the first electrode plate and the second electrode plate, a case accommodating the electrode assembly, the case being connected to the first electrode tab, a cap assembly including a cap plate bonded to an opening of the case and a terminal plate insulated from the cap plate, and connecting the second electrode tab by coming into contact with and being connected to a first portion of the terminal plate facing the electrode assembly, and a conductive member in a second portion of the terminal plate different from the first portion.

### CROSS-REFERENCE TO RELATED APPLICATION

This application claims priority under 35 U.S.C. §119 to Korean Patent Application No. 10-2024-0097132, filed in the Korean Intellectual Property Office on July 23, 2024, the entire contents of which are hereby incorporated by reference.

### BACKGROUND

### 1. Field

The present disclosure relates to a battery and a battery manufacturing method.

### 2. Description of Related Art

An electrode tab of an electrode assembly accommodated inside a case of a battery case is connected to an electrode terminal to be energized with an external electronic device. When vibration or dropping events occur in the battery, the flow of the electrode assembly may cause stress concentration in a portion where the electrode tab is connected to the electrode terminal. As a result, cracks may occur in the electrode tab or electrode terminal of the portion. Stress may be concentrated in the connection portion between the electrode tab and the electrode terminal, and thus, adhesive strength between the electrode tab and the electrode terminal may deteriorate. As a result, conductivity may be weakened.

The above information disclosed in this Background section is for enhancement of understanding of the background of the present disclosure, and therefore, it may contain information that does not constitute related (or prior) art.

### SUMMARY

Embodiments include a battery, the battery including an electrode assembly including a first electrode plate to which a first electrode tab is connected, a second electrode plate to which a second electrode tab is connected, and a separator interposed between the first electrode plate and the second electrode plate, a case accommodating the electrode assembly, the case being connected to the first electrode tab, a cap assembly including a cap plate bonded to an opening of the case and a terminal plate insulated from the cap plate, the second electrode tab contacting and being connected to a first portion of the terminal plate facing the electrode assembly, and a conductive member in a second portion of the terminal plate different from the first portion.

The terminal plate may include a tab connection surface connected to the second electrode tab, and a shape of the tab connection surface may be circular or polygonal.

The first portion may be a central region of the tab connection surface, and the second portion may be an outer region of the tab connection surface.

The first portion may be an outer region of the tab connection surface, and the second portion may be a central region of the tab connection surface.

The conductive member may be an isotropic conductive adhesive or an anisotropic conductive adhesive.

The conductive member may be a conductive film having an adhesive material on at least one surface.

The conductive member may be a conductive paste.

The battery may be a coin battery or a button battery.

The terminal plate may include a protrusion inserted into a central hole of the cap plate and a flange connected to an upper portion or a lower portion of the protrusion.

The protrusion may face the electrode assembly.

A size of the second electrode tab may be larger than a size of an end surface of the protrusion to which the second electrode tab is connected.

The first portion may be a central region of an end surface of the protrusion, and the second portion may be an outer region of the end surface of the protrusion.

The first portion may be an outer region of the end surface of the protrusion, and the second portion may be a central region of the end surface of the protrusion.

A size of the second electrode tab may be smaller than a size of an end surface of the protrusion to which the second electrode tab is connected.

The first portion may be a central region of a surface of the end surface of the protrusion corresponding to the second electrode tab, and the second portion may be an outer region of the surface of the end surface of the protrusion corresponding to the second electrode tab.

The first portion may be an outer region of a surface of the end surface of the protrusion corresponding to the second electrode tab, and the second portion may be a central region of the end surface of the protrusion corresponding to the second electrode tab.

Embodiments include a battery manufacturing method, including providing an electrode assembly including a first electrode plate to which a first electrode tab is connected, a second electrode plate to which a second electrode tab is connected, and a separator interposed between the first electrode plate and the second electrode plate, inserting the electrode assembly into a case and then connecting the first electrode tab to the case by welding, arranging a conductive member in a part on a terminal plate insulated from a cap plate of a cap assembly, arranging the second electrode tab on the terminal plate in which the conductive member is partially arranged and thermally compressing the second electrode tab, connecting the second electrode tab to the terminal plate by welding an outside of the second electrode tab corresponding to a portion other than a portion where the conductive member is arranged, and bonding the cap assembly to an opening of the case.

The arranging of the conductive member in the part on the terminal plate insulated from the cap plate of the cap assembly may include applying a conductive paste as the conductive member to the part on the terminal plate and drying the conductive paste.

The arranging of the conductive member in the part on the terminal plate insulated from the cap plate of the cap assembly may include providing, as the conductive member, a conductive film having a size corresponding to the part on the terminal plate, and attaching the conductive film to the part on the terminal plate.

The conductive member may be an isotropic conductive member or an anisotropic conductive member.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings.

FIG. 1 is a perspective view illustrating a battery according to one or more embodiments of the present disclosure;

FIG. 2 is a sectional view taken along line A-A' of FIG. 1;

FIG. 3 is a diagram illustrating a connection portion between the terminal plate and the electrode tab according to one or more embodiments of the present disclosure;

FIG. 4 is a diagram illustrating a connection portion between the terminal plate and the electrode tab according to one or more embodiments of the present disclosure;

FIG. 5 is a sectional view taken along line B-B' of FIG. 4;

FIG. 6 is a diagram illustrating the connection portion of the terminal plate and the electrode tab according to one or more embodiments of the present disclosure;

FIG. 7 is a sectional view taken along line B-B' of FIG. 6;

FIG. 8 is a diagram illustrating the connection portion between the terminal plate and the electrode tab according to one or more embodiments of the present disclosure;

FIG. 9 is a sectional view taken along line B-B' of FIG. 8;

FIG. 10 is a flowchart for describing a battery manufacturing method according to one or more embodiments of the present disclosure; and

FIGS. 11 to 15 are diagrams for describing the battery manufacturing method according to one or more embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations illustrated in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

The terms used in present specification are used for describing embodiments of the present disclosure and are not intended to limit the present disclosure.

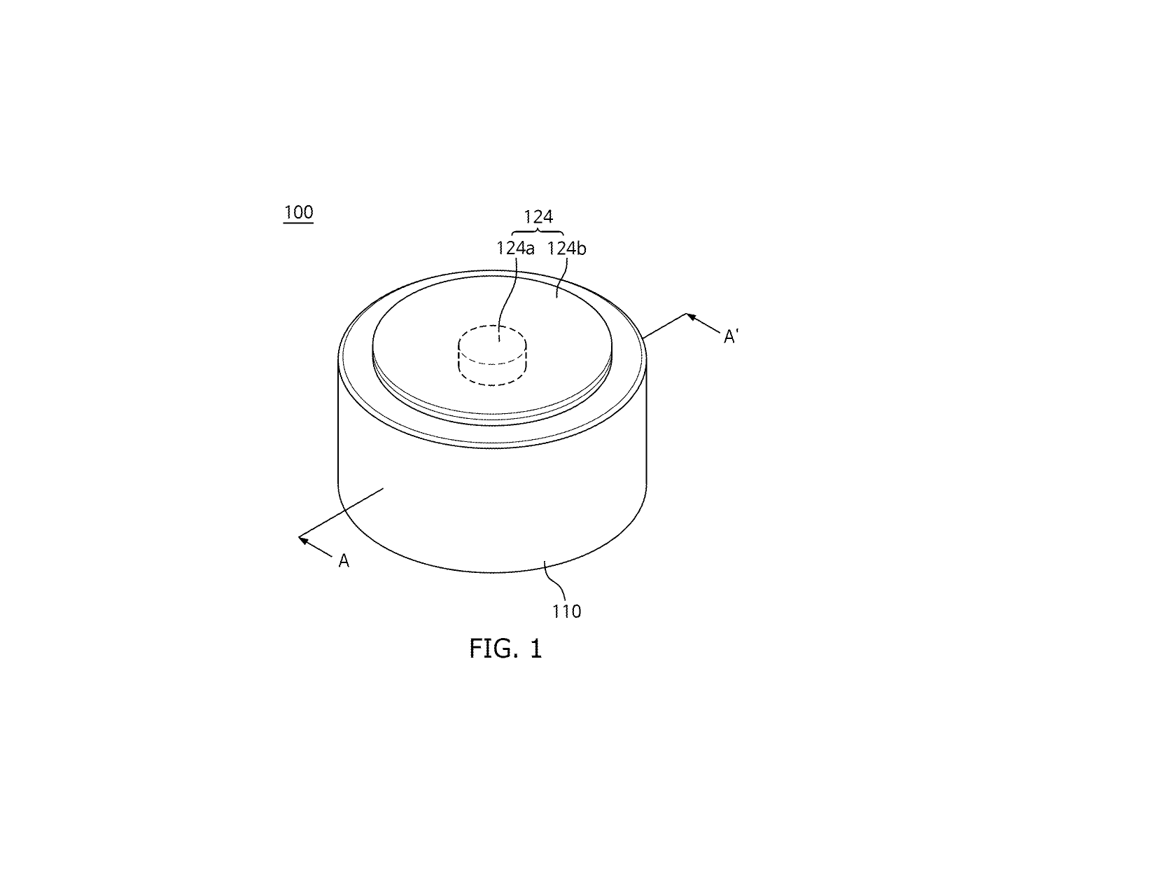

FIG. 1 is a perspective view illustrating a battery according to one or more embodiments of the present disclosure.

A battery 100 according to one or more embodiments of the present disclosure may be a microbattery, but is not limited to, a coin cell or a button cell, and may be a cylindrical or pin-shaped battery. In other embodiments, the battery 100 may be a square battery or a pouch-shaped battery.

In one or more embodiments, the coin cell or the button cell may mean a battery in a shape of a thin coin or button, and may mean, but is not limited to, a battery of which a ratio of a height to diameter (height/diameter) is 1 or less. Because the coin battery or the button battery is usually cylindrical, a section in a horizontal direction (in the orientation shown in FIG. 1) may be, but is not limited to, circular, and may also include a shape of which a section in a horizontal direction is oval or polygonal. In one or more embodiments, the diameter may mean a maximum distance based on the horizontal direction of the battery, and the height may mean a maximum distance (a distance from a flat bottom surface to a flat top surface) based on a vertical direction of the battery.

The battery 100 according to one or more embodiments may be a rechargeable secondary battery or a non-rechargeable primary battery. Referring to FIG. 1, the battery 100 may include an electrode assembly formed by stacking or winding unit cells in which a positive electrode plate, a negative electrode plate, and a separator interposed therebetween are stacked, and a case 110 that accommodates the electrode assembly. For example, the electrode assembly may be a stacked or wound electrode assembly.

The case 110 according to one or more embodiments may include an opening with an open top, and a cap assembly may be bonded to the opening. Referring to FIG. 1, the case 110 may be, but is not limited to, cylindrical, and may be a square or pouch-shaped case. The case may have both an opening with an open top and an opening with an open bottom instead of having only the opening with the open top. The cap assembly may include a terminal plate 124 that may function as a positive terminal or a negative terminal. The terminal plate 124 may include a protrusion 124a and a flange 124b. A specific structure of the cap assembly and a bonding relationship with the cap plate will be described later.

According to one or more embodiments, the protrusion 124a may be a structure extending in a direction toward the electrode assembly or in an opposite direction thereof based on the cap assembly bonded to the opening of the case 110. For example, as illustrated in FIG. 1, the protrusion 124a may be a cylindrical structure facing one side of the electrode assembly or an inside of the case 110. In the present disclosure, the protrusion may be, but is not limited to, the cylindrical structure, and may have various shapes such as a rectangle, a square, or a triangle.

According to one or more embodiments, the flange 124b may be a structure that is bonded to an upper surface or a lower surface of the protrusion 124a described above and protrudes in a diameter direction of the opening of the case 110 more than the protrusion 124a. For example, as illustrated in FIG. 1, the flange may be bonded to the upper surface of the protrusion 124a and may have a shape protruding in the diameter direction of the opening of the case 110 more than the protrusion 124a. In one or more embodiments, the protrusion 124a bonded to the lower surface of the flange 124b and may face the electrode assembly, and the flange 124b may be bonded to the cap plate. As a result, the terminal plate 124 may be connected to be energized with the electrode assembly accommodated inside the case 110 and may be energized with an electronic device that may be connected externally.

Referring to FIG. 1, although it has been illustrated that the terminal plate 124 is bonded to the upper surface of the case 110, the present disclosure is not limited thereto, and the terminal plate may be bonded to the lower surface of the case 110. The specific structure of the terminal plate 124 will be described later.

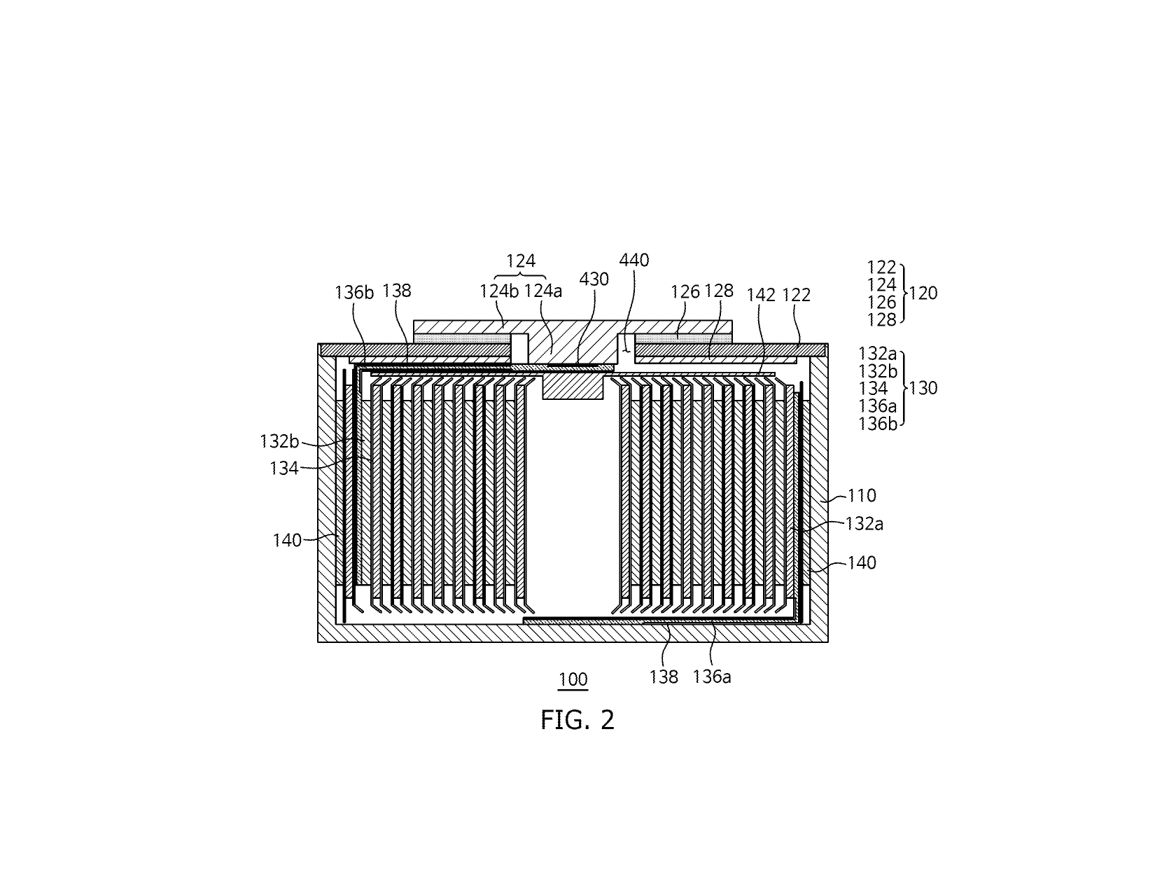

FIG. 2 is a sectional view taken along line A-A' of FIG. 1. A section taken along line A-A' of FIG. 1 may be a section taken along a winding axis of the wound electrode assembly accommodated in the substantially cylindrical case in FIG. 1.

According to one or more embodiments of the present disclosure, an electrode assembly 130 including a first electrode plate 132a to which a first electrode tab 136a is connected, a second electrode plate 132b to which a second electrode tab 136b is connected, and a separator 134 interposed between the first electrode plate 132a and the second electrode plate 132b may be accommodated inside the case 110 of the battery 100. In one or more embodiments, the first electrode may mean a positive electrode, and the second electrode may mean a negative electrode. In other embodiments, the first electrode may mean the negative electrode and the second electrode may mean the positive electrode.

One end of the first electrode tab 136a may be connected to the first electrode plate 132a to be energized with the first electrode plate 132a. The first electrode tab 136a and the first electrode plate 132a may be connected by welding or the like, or a bare portion of the first electrode plate 132a to which a first electrode mixture is not applied may protrude outward to form the first electrode tab 136a.

One end of the second electrode tab 136b may be connected to the second electrode plate 132b to be energized with the first electrode plate 132a. The second electrode tab 136b and the second electrode plate 132b may be connected by welding or the like, or a bare portion of the second electrode plate 132b to which the first electrode mixture is not applied may protrude outward to form the second electrode tab 136b.

The case 110 of the battery according to one or more embodiments may accommodate the electrode assembly described above inside, and the first electrode tab 136a may be connected inside. For example, referring to FIG. 2, the first electrode tab 136a may be connected to the case 110 by welding or the like on an inner surface of the case 110, for example, on a bottom surface in the orientation shown. As a result, the case 110 may be energized with the first electrode tab 136a and the first electrode plate 132a.

As illustrated in FIG. 1, a cap assembly 120 according to one or more embodiments may include a cap plate 122 bonded to the opening of the case 110, the terminal plate 124 insulated from an insulating layer 126 through the cap plate 122, and an insulating member 128. As described above, the terminal plate 124 may be energized with the second electrode plate 132b of the electrode assembly 130, and the cap plate 122 that may be bonded to the case 110 and the opening of the case may be energized with the first electrode plate 132a. Accordingly, in order to prevent a short circuit between the cap plate 122 and the case 110 that physically come into contact with each other, the insulating layer 126 may be arranged between the terminal plate 124 and the cap plate 122, as illustrated in FIG. 2.

The insulating layer 126 may be made of an insulating material and may be electrically insulate between the terminal plate 124 and the cap plate 122. The insulating layer 126 has adhesive strength, and may bond the terminal plate 124 and the cap plate 122 together.

The insulating member 128 may be arranged on a lower surface of the cap plate 122. For example, the insulating member may be arranged between the cap plate 122 and the electrode assembly 130. An upper surface of the cap plate 122 may face the flange 124b of the terminal plate 124, and the lower surface of the cap plate 122 may face the electrode assembly 130. The insulating member 128 may be made of an insulating material, and may electrically insulate between the cap plate 122 and the electrode assembly 130 and between the cap plate 122 and the second electrode tab 136b.

The terminal plate 124 may include the protrusion 124a and the flange 124b. The cap plate 122 may have a disc shape including a central hole 440 with an open central portion. According to one or more embodiments, as illustrated in FIG. 2, the protrusion 124a may be inserted into the central hole 440 of the cap plate 122 in the direction toward the electrode assembly 130, and the flange 124b bonded to the upper surface of the protrusion 124a may be connected to the cap plate 122 with the insulating layer 126 interposed therebetween.

In one or more embodiments, the second electrode tab 136b may come into contact with and be connected to a first portion of the terminal plate 124 facing the electrode assembly 130. A conductive member 430 may be arranged (e.g., situated) in a second portion of the terminal plate 124 different from the first portion. In one or more embodiments, the second electrode tab 136b and the first portion may be connected by welding. The first portion and the second portion may mean parts of a surface of the terminal plate 124 facing the electrode assembly 130. For example, the first portion and the second portion may mean parts of a lower surface of the protrusion 124a, as illustrated in FIG. 2. Referring to FIG. 2, although it has been illustrated that the conductive member 430 is arranged in a central region between the second electrode tab 136b and the protrusion 124a, the present disclosure is not limited thereto, and positions of the first portion and the second portion will be described later.

In one or more embodiments, each of the first electrode tab 136a and the second electrode tab 136b may be covered with a cover tape 138. The cover tape 138 may contain an insulating material. For example, because a short circuit may occur in a region other than a connection portion between the first electrode tab 136a and between the case 110 or the terminal plate 124 and the second electrode tab 136b, the cover tape 138 may be attached to the electrode tab other than the connection portion.

In one or more embodiments, the electrode assembly 130 may be covered with a sealing tape 140 along an outer peripheral surface in a diameter direction (in the orientation shown in FIG. 2). The sealing tape 140 may electrically insulate between the outer peripheral surface of the electrode assembly 130 and the inner surface of the case 110 while protecting an outside of the electrode assembly 130. The winding of the first electrode plate 132a, the second electrode plate 132b, and the separator 134 may be fixed without being unwound by the sealing tape 140. The sealing tape 140 may contain at least one of polyimide (PI), polyethylene (PE), or polystyrene (PS).

In the present disclosure, although it has been described that the second electrode tab 136b is connected to the terminal plate 124 and the first electrode tab 136a is connected to the case 110, the present disclosure is not limited thereto. For example, the first electrode tab 136a may be connected to the terminal plate 124, and the second electrode tab 136b may be connected to the case 110. In other embodiments, the first electrode tab 136a and the second electrode tab 136b may be bonded to terminal plates formed on upper and lower portions of the case 110, respectively.

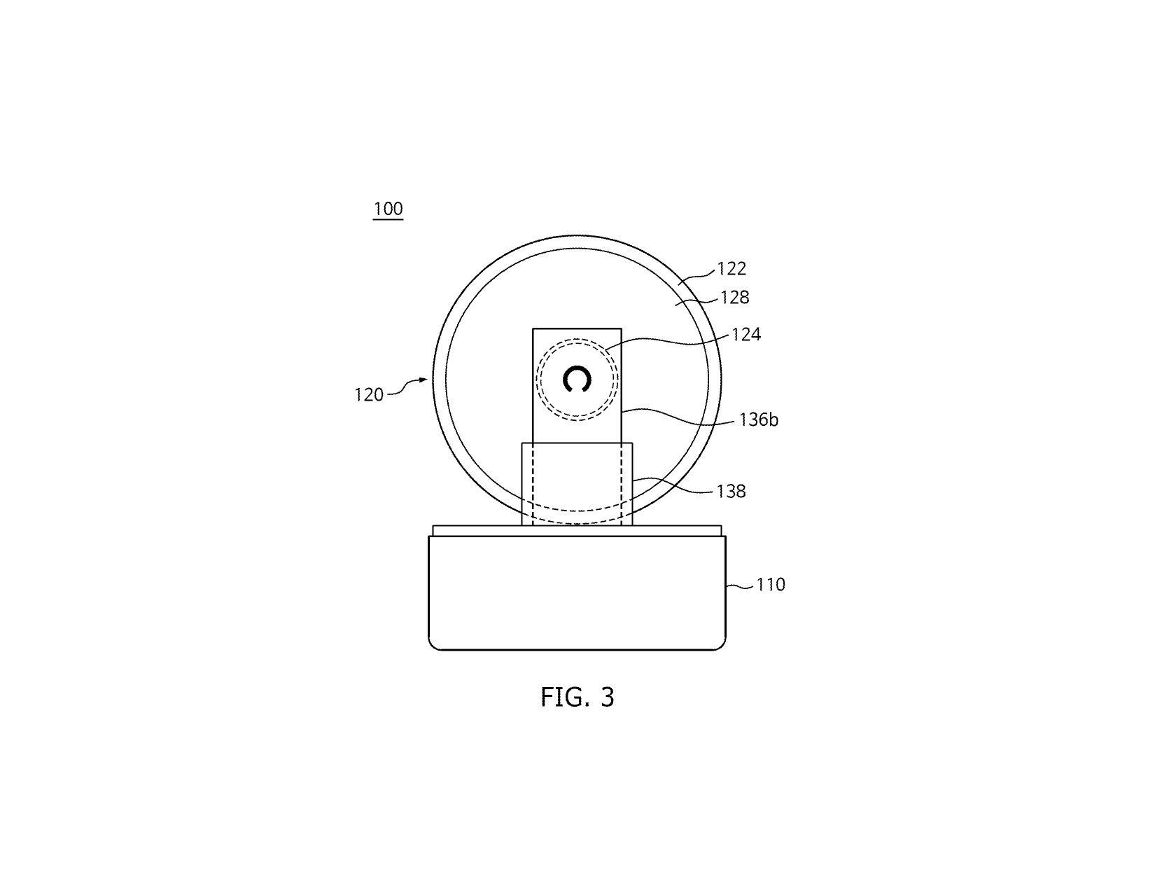

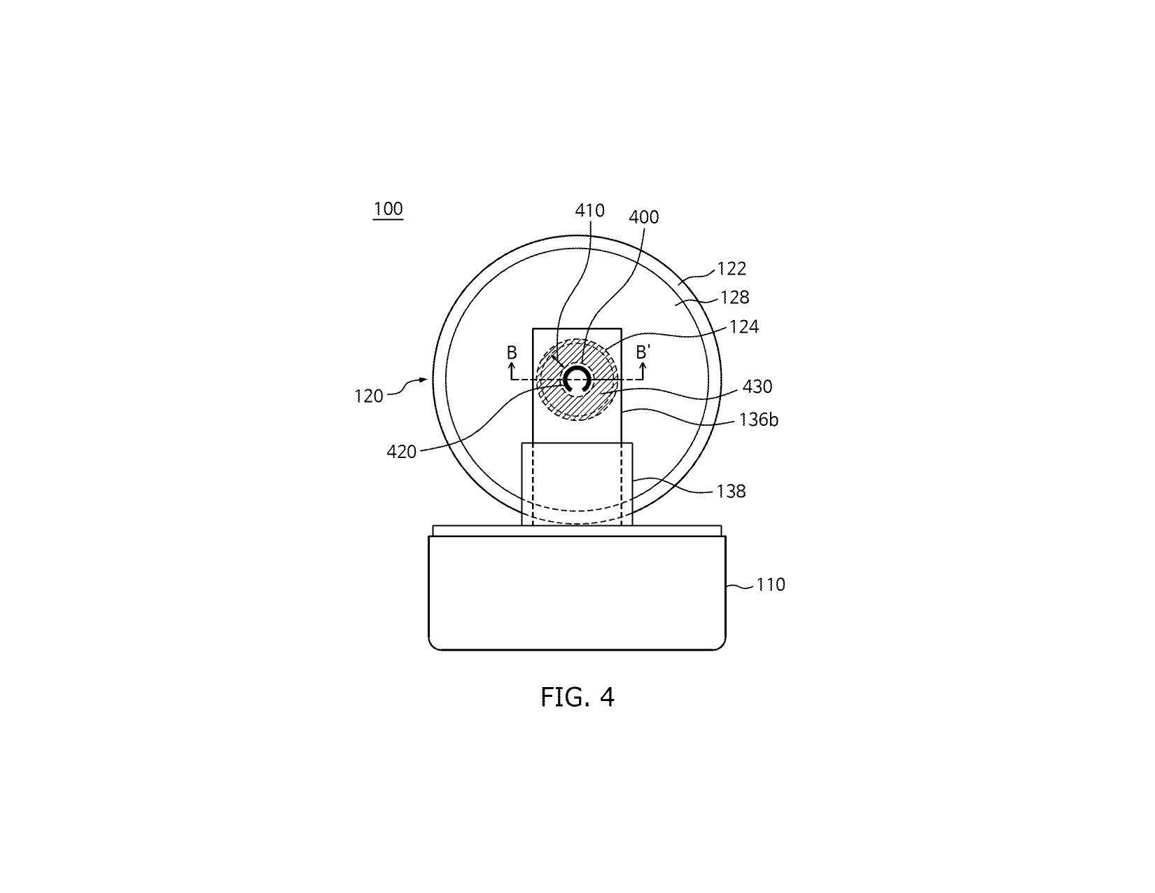

FIGS. 3 and 4 are diagrams illustrating a connection portion between the terminal plate and the electrode tab according to one or more embodiments of the present disclosure. FIGS. 3 and 4 are diagrams illustrating the connection portion when the second electrode tab 136b bonded to the cap assembly 120 is viewed in a state where the opening of the battery case 110 is open.

Referring to FIG. 3, the insulating member 128 may be arranged on the lower surface of the cap plate 122 in the cap assembly 120. The terminal plate 124 penetrating through the central hole (for example, 440 in FIG. 2) of the cap plate 122 may be electrically connected to the second electrode tab 136b. In one or more embodiments, the terminal plate and the second electrode tab may be connected by welding. The second electrode tab 136b may be wrapped with the cover tape 138 to be electrically insulated from the cap plate 122 and/or the electrode assembly (for example, 130 in FIG. 2). As a result, the second electrode tab 136b may be electrically connected to the terminal plate 124, and the terminal plate 124 can function as a second electrode terminal.

In one or more embodiments, the terminal plate 124 may include a tab connection surface connected to the second electrode tab 136b. A shape of the tab connection surface can be circular or polygonal. The second electrode tab 136b may be larger or smaller than a size of a surface connected to the terminal plate 124. For example, the entire lower surface of the protrusion of the terminal plate (for example, 124a in FIG. 2) may be covered, or a part of the lower surface of the protrusion may be covered. Referring to FIGS. 3 and 4, the second electrode tab 136b covers the entire lower surface of the protrusion of the terminal plate 124, and thus, a shape of the tab connection surface may be substantially identical to a shape of the lower surface of the protrusion. For example, the shape of the tab connection surface may be circular, as illustrated in FIGS. 3 and 4.

Designs of a thickness, a width, and an edge shape of the electrode tab are factors in determining the full performance of the battery, and the thickness, width, and edge shape of the electrode tab may vary depending on a battery model. Accordingly, a shape of a connection surface with the terminal plate or the protrusion of the terminal plate may also be adjusted as described previously.

According to one or more embodiments, in a state where the cap plate 122 is assembled to the case 110, the second electrode tab 136b may come into contact with and be connected to the terminal plate 124 in a partial region of the portion of the terminal plate 124 facing the electrode assembly. The second electrode tab 136b may be connected by welding to the partial region of the terminal plate 124. Referring to FIG. 3, weld traces by welding may be formed on the terminal plate 124 and the second electrode tab 136b. The weld traces may be weld beads. The welding may be laser welding or ultrasonic welding. The laser welding has advantages of higher welding strength than the ultrasonic welding and real-time monitoring with vision.

In the case of the ultrasonic welding, cleaning needs to be separately performed in order to improve electrical contact quality and welding strength. In the laser welding, because cleaning and welding are simultaneously performed, processes may be simplified. Unlike the ultrasonic welding, due to repetition irradiation of a high-precision laser beam, contamination is vaporized, and the surface is preheated. As a result, the speed and quality of the welding may be improved.

A contact surface between the second electrode tab and the terminal plate may be widened in order to achieve high conductivity between the second electrode tab and terminals. However, the connection of the entire contact surface by welding may slow down a production speed as the number of welding processes increases. In the case of a microbattery, because an area of the contact surface is also ultra-small, the connection of the entire area of the contact surface by welding may reduce production efficiency. Due to several factors, such as vibration or dropping events occurring in the battery, incorrect welding may cause high electrical contact resistance, and a power-loss region may be generated. Whenever current passes through the battery, a peripheral portion may be damaged due to heat generation. The heat generation of one electrode tab may be small, but the total heat generated by modules and packs may lead to a major fire. Accordingly, the conductive member is introduced in order to enhance adhesive strength and conductivity between the second electrode tab and terminals.

However, as will be described below, the connection using the conductive member may have lower conductivity than in the case of welding. Accordingly, a method for connecting an electrode tab and a terminal in which current distribution and conductivity are maximized by utilizing advantages of both adhesion using the conductive member and bonding using welding will be described with respect to FIGS. 4 through 9.

Referring to FIG. 4, in one or more embodiments, the second electrode tab 136b may come into contact with and be connected to a first portion 400 of the terminal plate 124 facing the electrode assembly. The first portion 400 may be a partial region of the connection surface of the terminal plate 124 with the second electrode tab 136b. In one or more embodiments, the terminal plate and the second electrode tab may be connected by welding. The conductive member 430 may be arranged in a second portion 410 of the terminal plate 124 different from the first portion 400. The second portion 410 may be any region of the terminal plate 124 excluding the first portion 400. For example, the second portion 410 may be any region excluding the first portion 400 on the connection surface of the terminal plate 124 with the second electrode tab 136b. The second electrode tab 136b may be attached to the second portion 410 of the terminal plate 124 with the conductive member 430 interposed therebetween.

According to one or more embodiments, as illustrated in FIG. 4, the first portion 400 of the terminal plate 124 may be a central region of the tab connection surface, and the second portion 410 of the terminal plate 124 may be an outer region (e.g., a peripheral region outside the central region) of the tab connection surface. In one or more embodiments, when the conductive member 430 is arranged in the second portion 410, the adhesive strength and the conductivity between the terminal plate 124 and the second electrode tab 136b may be enhanced than when the conductive member 430 is not arranged.

Referring to FIG. 4, on the connection surface between the second electrode tab 136b and the terminal plate 124 according to one or more embodiments, when shapes of the first portion 400 and the second portion 410 are substantially circular, because the arrangement of the conductive member and the shape of a welding portion 420 are similar, the uniformity of the current distribution and the conductivity may be maximized. The welding portion 420 may be, but is not limited to, inside the first portion 400, but may be formed in a shape similar to the second portion 410 in order to achieve the uniformity of the current distribution.

When the shape of the conductive member 430 arranged in the second portion 410 of the terminal plate 124 is a ring shape as illustrated in FIG. 4, stress may be distributed evenly, and thus, the characteristics of the physical and mechanical connection may be more stable. The closer the welding portion is to the conductive member 430 while a position of the welding portion 420 in the first portion 400 does not overlap with a position where the conductive member 430 is arranged, the more uniform the current distribution may be.

In one or more embodiments, widths of the first portion 400 and the second portion 410 are not limited, but may be designed to be substantially equal in order to achieve optimal adhesive strength and conductivity between the second electrode tab and the terminal plate. In one or more embodiments, the width may mean a diameter thereof if the tab connection surface is circular. For example, referring to FIG. 4, the width of the first portion 400 may mean the diameter thereof, and the width of the second portion 410 may mean a length indicated by an arrow.

In the present disclosure, the welding may mean (may be) ultrasonic welding or laser welding. As a result, two metals of the second electrode tab 136b and the terminal plate 124 may be connected by a metal bonding method employing melting. The conductive member 430 may be an isotropic conductive adhesive (ICA) or an anisotropic conductive adhesive (ACA). The conductive member 430 may include both the isotropic conductive adhesive and the anisotropic conductive adhesive. The conductive member 430 can effectively attach the two metals of the second electrode tab 136b and the terminal plate 124 by being inserted between the two metals. Although maximum tensile strength of welding may be high, in the case of adhesion using the conductive member 430, an adhesion area may be wider than in the case of bonding by welding, and thus, an integral value of tensile strength may be larger. Accordingly, according to one or more embodiments of the present disclosure, uniform adhesive strength can be ensured over the entire surface of the connection surface in addition to local adhesion by welding or the like.

In one or more embodiments, the first portion 400 and the second portion 410 may not overlap with each other. The conductive member 430 may be a mixture of resin and conductive material, and when the first portion 400 and the second portion 410 overlap with each other, the resin and/or the conductive material may melt and swell during welding. When a region including the conductive member is welded, it may be difficult to design welding conditions. However, the present disclosure is not limited to the first portion 400 and the second portion 410 not overlapping with each other. When the conductive member is included, when the welding conditions are set, and when the first portion and the second portion overlap with each other, an effect of enhancing the adhesive strength and the conductivity may also be achieved.

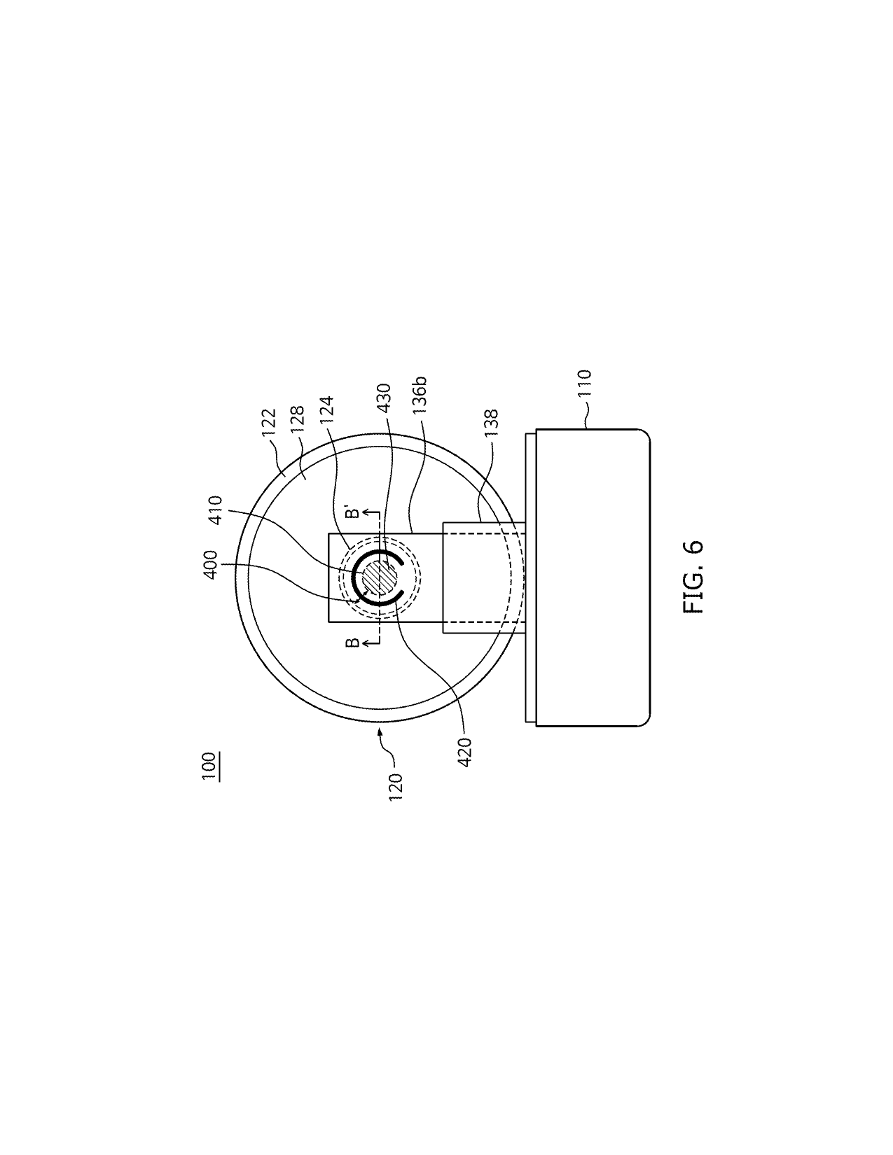

In one or more embodiments, as illustrated in FIG. 6, a size of the second electrode tab 136b may be larger than a size of an end surface of the protrusion of the terminal plate 124 to which the second electrode tab 136b is connected. The first portion 400 directly connected to the second electrode tab 136b may be an outer region of the end surface of the protrusion of the terminal plate 124, and the second portion 410 may be a central region of the end surface of the protrusion of the terminal plate 124. In one or more embodiments, the conductive member 430 may be arranged in the central region of the end surface of the protrusion.

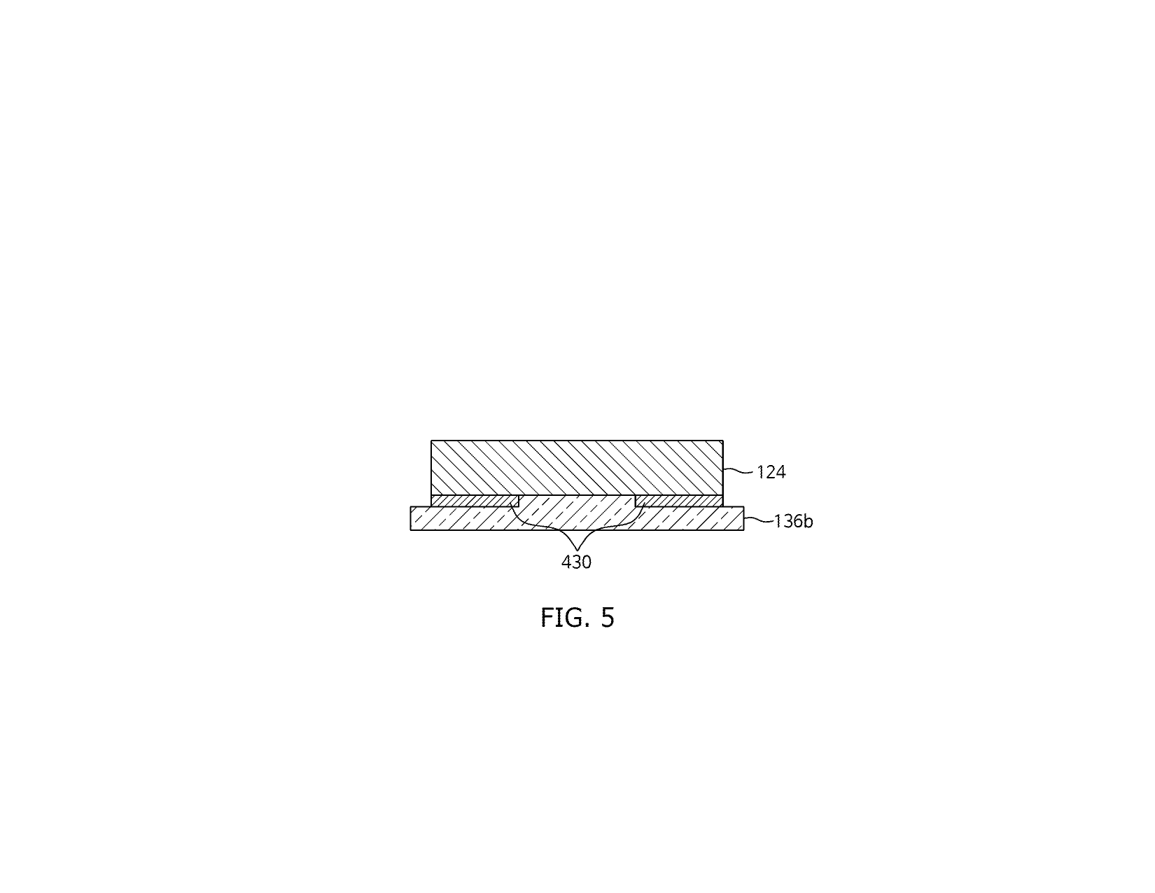

FIG. 5 is a sectional view taken along line B-B' of FIG. 4.

The conductive member 430 may be a conductive film including an adhesive material on at least one surface. Even though the conductive film contains an adhesive material on at least one surface, for example, when the conductive film is attached to the terminal plate 124 by thermocompression, the conductive film may be attached to the terminal plate 124 and the second electrode tab 136b. As another example, when there are adhesive properties on both surfaces, there may be an advantage in that stress concentration over the entire area can be prevented.

As another example, the conductive member 430 may be a conductive paste. The conductive paste may have adhesive properties to the entire area of a target by being applied in a liquid phase and being dried. Referring to FIG. 5, the conductive member 430 may be arranged between the terminal plate 124 and the second electrode tab 136b. For example, when the conductive member is the conductive film, the conductive member 430 may be attached to the terminal plate 124 and/or the second electrode tab 136b. If the conductive member 430 is the conductive paste, after the conductive paste is applied to the terminal plate 124 or the second electrode tab 136b, the second electrode tab 136b or the terminal plate 124 may be attached onto the conductive paste.

In the present disclosure, the conductive member 430 may be an electrically conductive adhesive (ECA) or just “conductive adhesive.” The conductive adhesive may contain, as principal components, polymer materials and conductive filler particles. The conductive adhesive may be used in a low-temperature process due to low thermal stress, and the process can be simplified because a separate cleaning process is not required due to the use of the conductive adhesive. There may be advantages in that fine pitch can be coped with and thermal fatigue characteristics can be improved. However, most conductive adhesives may have lower thermal and electrical conductivity and less impact resistance than in welding. Accordingly, the conductive member 430 according to one or more embodiments may be used together with the welding of the first portion (for example, 400 in FIG. 4) to bond the second electrode tab 136b and the terminal plate 124.

According to one or more embodiments, the conductive adhesive may be the isotropic conductive adhesive (ICA) through which current flows in all directions, or the anisotropic conductive adhesive (ACA) through which current flows in only one direction.

Principal components of the ICA may include polymer materials and conductive filler particles. The polymer material may be a thermoplastic resin, such as phenolic epoxy or polyimide, or a thermosetting resin (thermoset), such as epoxy, silicone, or polyurethane. A filler with a size ranging from several µm to tens of µm may be used as a conductive filler. A shape of the conductive filler may be a spherical shape or a flake shape for multiple points of surface contact.

According to one or more embodiments, conduction may be established between the second electrode tab 136b and the terminal plate 124 by mechanical and physical contact of the conductive fillers described above in the ICA arranged between the second electrode tab 136b and the terminal plate 124. A content of the filler may vary depending on the shape and size of the filler. For example, the content of the filler may be 30 vol% to 40 vol% of the entire ICA.

A material of the conductive filler may be silver (Ag), gold (Au), copper (Cu), nickel (Ni), carbon, metal plating filler, and the like. For example, Ag having low resistivity and conductive characteristics of oxide, may be used as the conductive filler. In other embodiments, Ni nanoparticles, which have higher electrical resistance than Ag but better chemical and thermal stability than Cu, can be used as a conductive filler. In other embodiments, in order to prevent or minimize damage to the battery (e.g., vibration or dropping events), an ICA with enhanced impact resistance may be used as the conductive member. For example, electrical characteristics and impact resistance of the connection between the second electrode tab 136b and the terminal plate 124 can be enhanced by using an ICA with carbon nanotubes (CNTs) and silver (Ag)-coated nanoparticles or an ICA using silver (Ag) nanowires.

Principal components of the ACA may include a thermosetting resin, a thermoplastic polymer material, and conductive filler particles. The ACA may be distinguished into an anisotropic conductive paste (ACP), which is a material that may be used by being printed or applied in a paste phase, and an anisotropic conductive film (ACF) which has a separation film for easily handling the ACF by preventing the ACF from being attached to a reel when the ACF is wound on the reel in the film state. Referring to FIG. 5, when the conductive member 430 according to one or more embodiments is the ACA, a conductive path may be formed only in a vertical direction (in the orientation shown) connecting the second electrode tab 136b and the terminal plate 124, and thus, current may flow in only one direction. Due to these features, for example, the ACF may be applied to the entire second portion (for example, 410 in FIG. 4) of the connection surface of the terminal plate 124 with the second electrode tab 136b, and thus, mechanical bonding and electrical connection between the terminal plate 124 and the second electrode tab 136b can be uniformly achieved.

When the conductive member 430 according to one or more embodiments is the ACA, mechanical and physical contact may be performed by conductive particles trapped on an upper surface of the terminal plate 124 on which the ACA is arranged. That is, electrical characteristics of a connection surface between the conductive member 430 and the terminal plate 124 may be determined depending on the average number of filler particles on the upper surface of the terminal plate 124, a degree of compression of the filler particles, and the like. Characteristics of the connection surface may vary depending on a joining temperature, time, pressure, and pressure distribution, flatness of the terminal plate 124, dispersion of the filler particles, the size of the filler particles, and the like.

In the present disclosure, although it has been described that the conductive member 430 is first arranged on the terminal plate 124 having higher rigidity than the second electrode tab 136b, the conductive member may be first arranged on the second electrode tab 136b. In one or more embodiments, the characteristics of the connection surface described above may be changed by the average number of filler particles on the upper surface of the second electrode tab 136b, the flatness of the second electrode tab 136b, and the like.

According to one or more embodiments, when the conductive member 430 is arranged and welded as illustrated in FIG. 4, on the section along the line B-B', the second electrode tab 136b may be bonded to the terminal plate 124 on both sides of the connection surface with the terminal plate with the conductive member 430 interposed therebetween, as illustrated in FIG. 5. A region inside the conductive member 430 may be a region where the second electrode tab 136b and the terminal plate 124 are bonded by welding. Due to welding, the same kind or different kinds of metals of the second electrode tab 136b and the terminal plate 124 may be bonded. In one or more embodiments, due to a volume of the conductive member 430, a minute stepped portion may be formed between the welding portion (for example, 420 in FIG. 4) and the conductive member 430, as illustrated in FIG. 5.

The second electrode tab may be connected to the terminal plate along a line close to the stepped portion described above. For example, laser welding may be performed along the line close to the stepped portion, and thus, a weld bead or the like may be formed around the stepped portion. However, the present disclosure is not limited thereto, and connection may be performed by welding in the region inside the first portion 400. However, when connection is performed in a circular shape around the stepped portion for the sake of convenience in the process, because the arrangement of the conductive member and the shape of the welding portion 420 are similar, the current distribution and the conductivity can be maximized.

Referring to FIG. 5, the second electrode tab 136b may be larger (e.g., wider) than the size (e.g., width) of the terminal plate 124 and/or the protrusion of the terminal plate 124, and thus, an end of the conductive member 430 on the connection surface with the terminal plate 124 may be formed as an end on a surface substantially identical to an end of the terminal plate 124 and/or the protrusion of the terminal plate 124. The welding portion 420 of the terminal plate 124 and the second electrode tab 136b may be arranged between the other ends of the conductive member 430.

FIG. 6 is a diagram illustrating the connection portion of the terminal plate and the electrode tab according to one or more embodiments of the present disclosure. Differences from FIG. 4 will be described.

Referring to FIG. 6, the first portion 400 of the terminal plate 124 according to one or more embodiments may be an outer region of the connection surface between the terminal plate 124 and the second electrode tab 136b, and the second portion 410 different from the first portion 400 may be a central region of the connection surface between the terminal plate 124 and the second electrode tab 136b. In one or more embodiments, the conductive member 430 may be arranged (e.g., situated) in the second portion 410 of the terminal plate 124, and the second electrode tab 136b may be bonded on the conductive member 430.

In one or more embodiments, referring to FIG. 6, the second electrode tab may come into contact with and be connected to the first portion 400 of the terminal plate facing the electrode assembly. In one or more embodiments, the terminal plate and the second electrode tab may be connected by welding. The second electrode tab may be attached to the second portion 410 of the terminal plate with the conductive member interposed therebetween.

Referring to FIG. 6, on the connection surface between the second electrode tab 136b and the terminal plate 124 according to one or more embodiments, when the shapes of the first portion 400 and the second portion 410 are substantially circular, because the arrangement of the conductive member and the shape of the welding portion 420 are similar, the uniformity of current distribution and the conductivity can be maximized. The welding portion 420 may be, but is not limited to, inside the first portion 400, but may be formed in a shape similar to the second portion in order to achieve the uniformity of the current distribution. For example, the first portion may be formed in a ring shape, and the second portion may be formed in a circle shape.

When the shape of the conductive member 430 arranged on the second portion 410 of the terminal plate 124 is a circular shape as illustrated in FIG. 6, stress may be distributed evenly, and thus, the characteristics of the physical and mechanical connection can be more stable. The closer the welding portion is to the conductive member 430 while a position of the welding portion 420 in the first portion 400 does not overlap with a position where the conductive member 430 is arranged, the more uniform the current distribution may be.

According to one or more embodiments, the widths of the first portion 400 and the second portion 410 are not limited, but may be designed to be substantially equal in order to achieve optimal adhesive strength and conductivity between the second electrode tab 136b and the terminal plate 124. In one or more embodiments, the width may mean a diameter thereof when the tab connection surface is circular. For example, referring to FIG. 6, the width of the second portion 410 may mean the diameter thereof, and the width of the first portion 400 may mean a length indicated by an arrow.

In one or more embodiments, as illustrated in FIG. 6, the size of the second electrode tab 136b may be larger than the size of the end surface of the protrusion of the terminal plate 124 to which the second electrode tab is connected. The first portion 400 directly connected to the second electrode tab may be a central region of the end surface of the protrusion of the terminal plate 124, and the second portion 410 may be an outer region of the end surface of the protrusion of the terminal plate. In one or more embodiments, the conductive member 430 may be arranged in the outer region of the end surface of the protrusion. In one or more embodiments, the connection may be performed by welding, and the conductive member 430 may contain a conductive material. As a result, the adhesive strength and the conductivity between the terminal plate 124 and the second electrode tab 136b can be further enhanced.

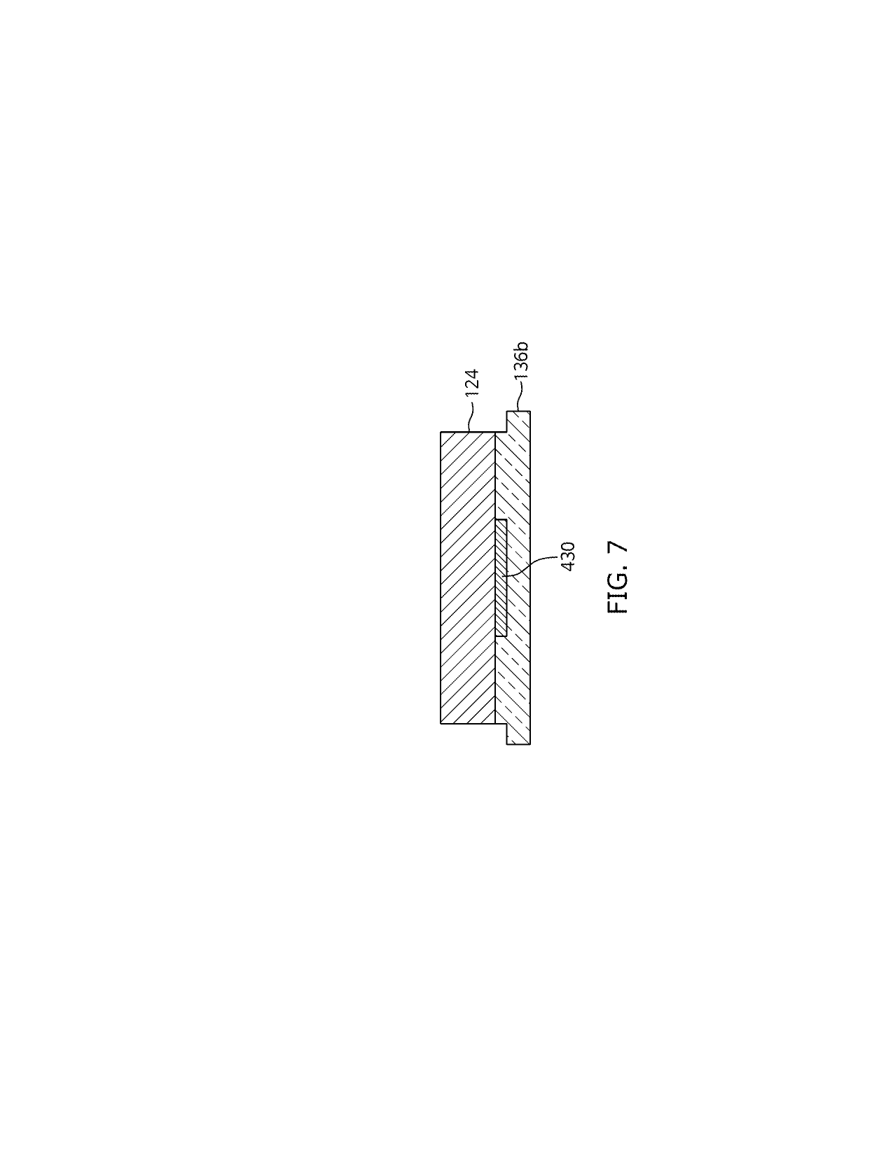

FIG. 7 is a sectional view taken along line B-B' of FIG. 6. Differences from FIG. 5 will be described.

According to one or more embodiments, when the conductive member 430 is arranged and welded as illustrated in FIG. 6, on the section along the line B-B', the second electrode tab 136b may be bonded to the terminal plate 124 (at the center of the connection surface) with the conductive member 430 interposed therebetween, as illustrated in FIG. 7. A peripheral region of the conductive member 430 may be a region where the second electrode tab 136b and the terminal plate 124 are bonded by welding. Due to welding, the same kind or different kinds of metals of the second electrode tab 136b and the terminal plate 124 may be bonded. In one or more embodiments, due to a volume of the conductive member 430, a minute stepped portion may be formed between the welding portion (for example, 420 in FIG. 6) and the conductive member 430, as illustrated in FIG. 7.

The second electrode tab 136b may be connected to the terminal plate 124 along a line close to the stepped portion described above. For example, laser welding may be performed along the line close to the stepped portion, and thus, a weld bead or the like may be formed around the stepped portion. However, the present disclosure is not limited thereto, and connection may be performed by welding in the region inside the first portion 400. However, when connection is performed in a circular shape around the stepped portion for the sake of convenience in the process, because the arrangement of the conductive member 430 and the shape of the welding portion 420 are similar, the current distribution and the conductivity can be maximized.

Referring to FIG. 7, a size of the second electrode tab 136b may be larger than a size of the terminal plate 124 and/or the protrusion of the terminal plate 124. In one or more embodiments, after both welding in the first portion (for example, 400 in FIG. 6) and thermal fusion in the second portion (for example, 410 in FIG. 6) are performed, one end of the pressed second electrode tab 136b may be formed as an end on a surface substantially identical to an end of the terminal plate 124 and/or the protrusion of the terminal plate 124. The conductive member 430 may be arranged between the other ends of the pressed second electrode tab 136b.

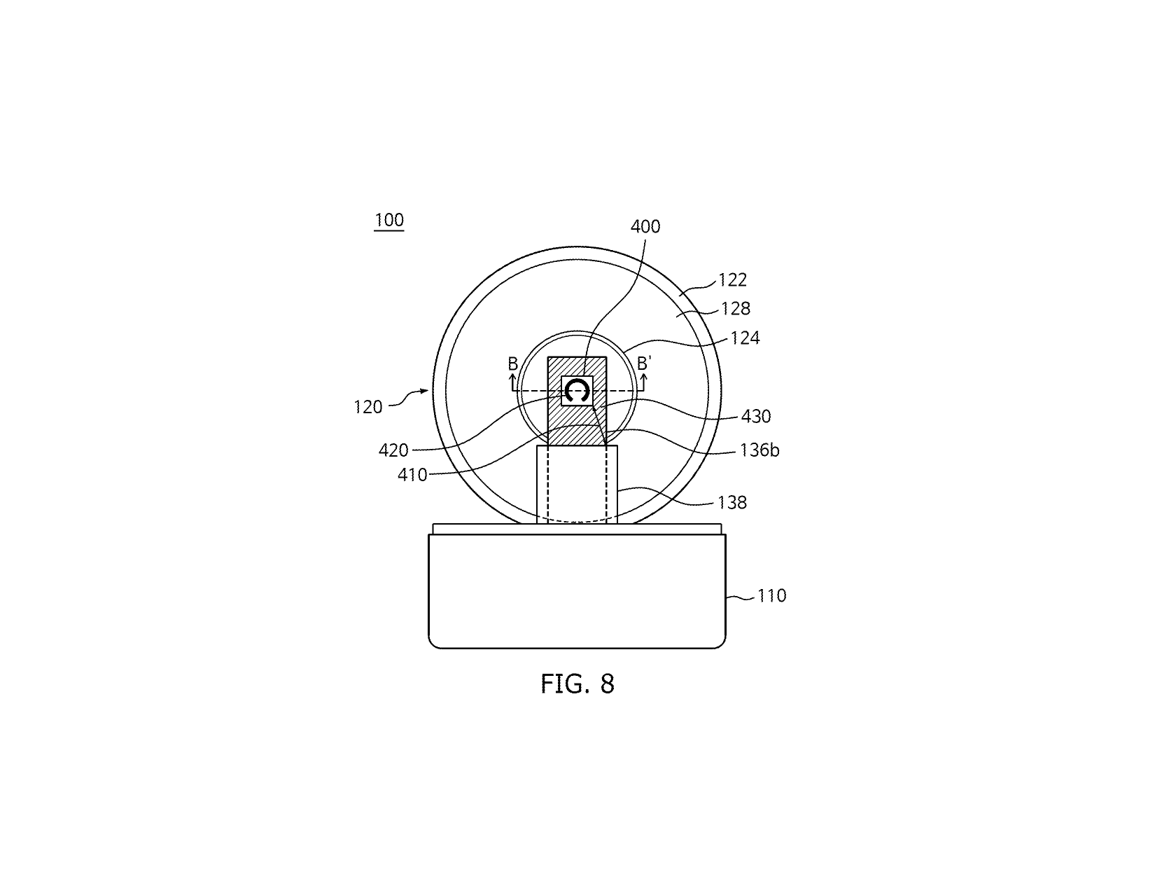

FIG. 8 is a diagram illustrating the connection portion between the terminal plate and the electrode tab according to one or more embodiments of the present disclosure. The descriptions overlapping with the above-mentioned contents are omitted.

According to one or more embodiments, a size of the second electrode tab 136b may be smaller than a size of the end surface of the protrusion of the terminal plate 124 to which the second electrode tab 136b is connected. In one or more embodiments, referring to FIG. 8, the first portion 400 may be a central region of a surface of the end surface of the protrusion of the terminal plate 124 corresponding to the second electrode tab 136b, and the second portion 410 may be an outer region of a surface of the end surface of the protrusion of the terminal plate 124 corresponding to the second electrode tab 136b. In one or more embodiments, the surface corresponding to the second electrode tab 136b may mean the connection surface of the terminal plate 124 with the second electrode tab.

Referring to FIG. 8, the first portion 400 of the terminal plate 124 may have a substantially rectangular shape similar to the shape of the electrode tab. However, the present disclosure is not limited thereto, and an outer end may be rectangular along the shape of the electrode tab, and an inner end may be substantially circular. When the conductive member 430 is arranged in a shape that fills an outer edge of the connection surface, the uniformity of the current distribution and the conductivity can be maximized. A shape of the welding portion 420 formed on the first portion 400 of the terminal plate 124 may be substantially similar to the shape of the conductive member 430 arranged on the second portion 410, or may be formed along a line of a stepped portion formed by the conductive member 430.

Referring to FIG. 8, the second portion 410 of the terminal plate 124 may mean only a part of the protrusion of the terminal plate 124. The second portion 410 of the terminal plate 124 may have a shape that fills an outer edge of the second electrode tab 136b. A width of the second portion 410 may mean a length of an arrow illustrated in FIG. 8. A width of the first portion 400 may mean a maximum length from a center point of the tab connection surface.

According to one or more embodiments, the first portion 400 of the terminal plate 124 may be an outer region of a surface of the end surface of the protrusion of the terminal plate 124 corresponding to the second electrode tab 136b, and the second portion 410 may be a central region of a surface of the end surface of the protrusion of the terminal plate 124 corresponding to the second electrode tab 136b. In one or more embodiments, the surface corresponding to the second electrode tab 136b may mean the connection surface of the terminal plate 124 with the second electrode tab.

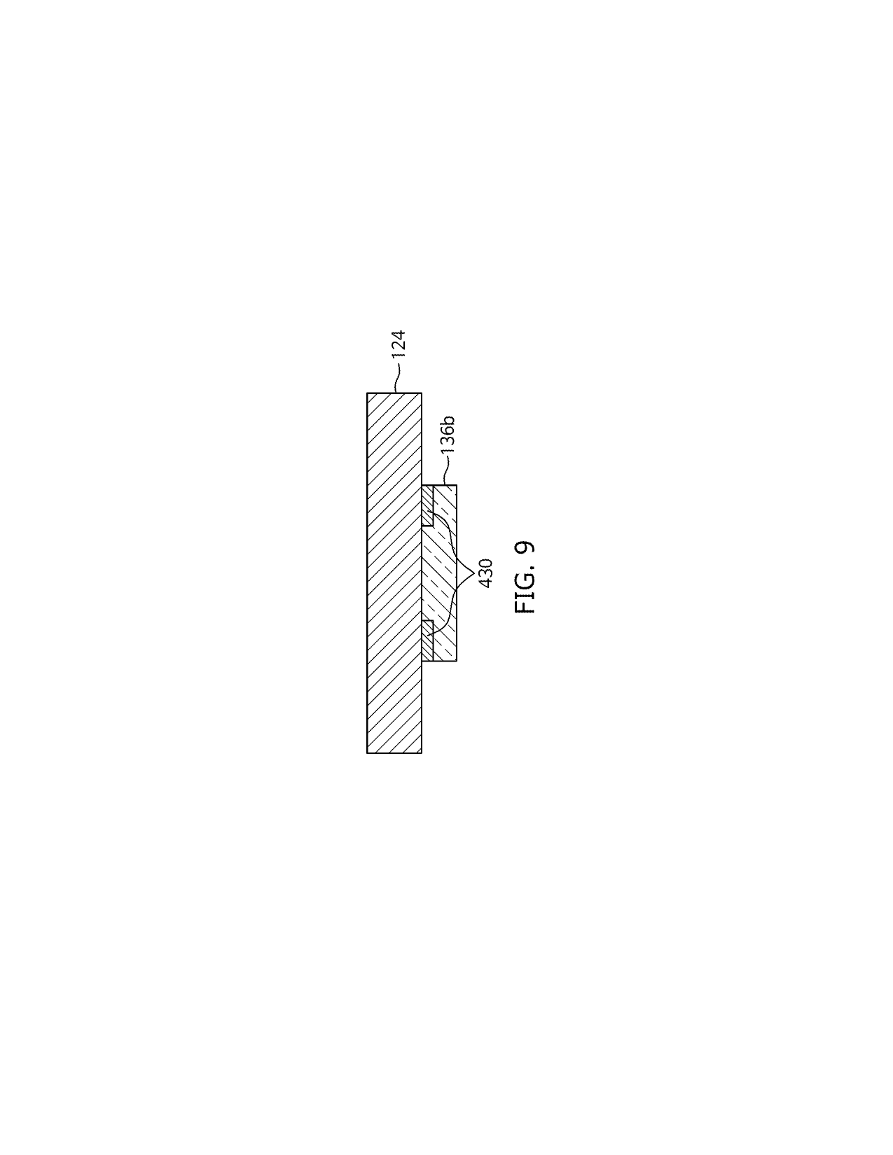

FIG. 9 is a sectional view taken along line B-B' of FIG. 8. The contents overlapping with the above-mentioned contents are omitted.

According to one or more embodiments, when the conductive member 430 is arranged and welded as illustrated in FIG. 8, on the section along the line B-B', the second electrode tab 136b may be bonded to the terminal plate 124 on both sides of the connection surface with the terminal plate with the conductive member 430 interposed therebetween, as illustrated in FIG. 9. A region inside the conductive member 430 may be a region where the second electrode tab 136b and the terminal plate 124 are bonded by welding. Due to welding, the same kind or different kinds of metals of the second electrode tab 136b and the terminal plate 124 may be bonded. In one or more embodiments, due to a volume of the conductive member 430, a minute stepped portion may be formed between the welding portion (for example, 420 in FIG. 8) and the conductive member 430, as illustrated in FIG. 9.

Referring to FIG. 9, a size of the second electrode tab 136b may be smaller than a size of the terminal plate 124 and/or the protrusion of the terminal plate 124, and thus, one end of the conductive member 430 on the connection surface with the terminal plate 124 may be formed as an end different from an end of the terminal plate 124 and/or the protrusion of the terminal plate 124. The welding portion (for example, 420 in FIG. 8) of the terminal plate 124 and the second electrode tab 136b may be arranged between the other ends of the conductive member 430.

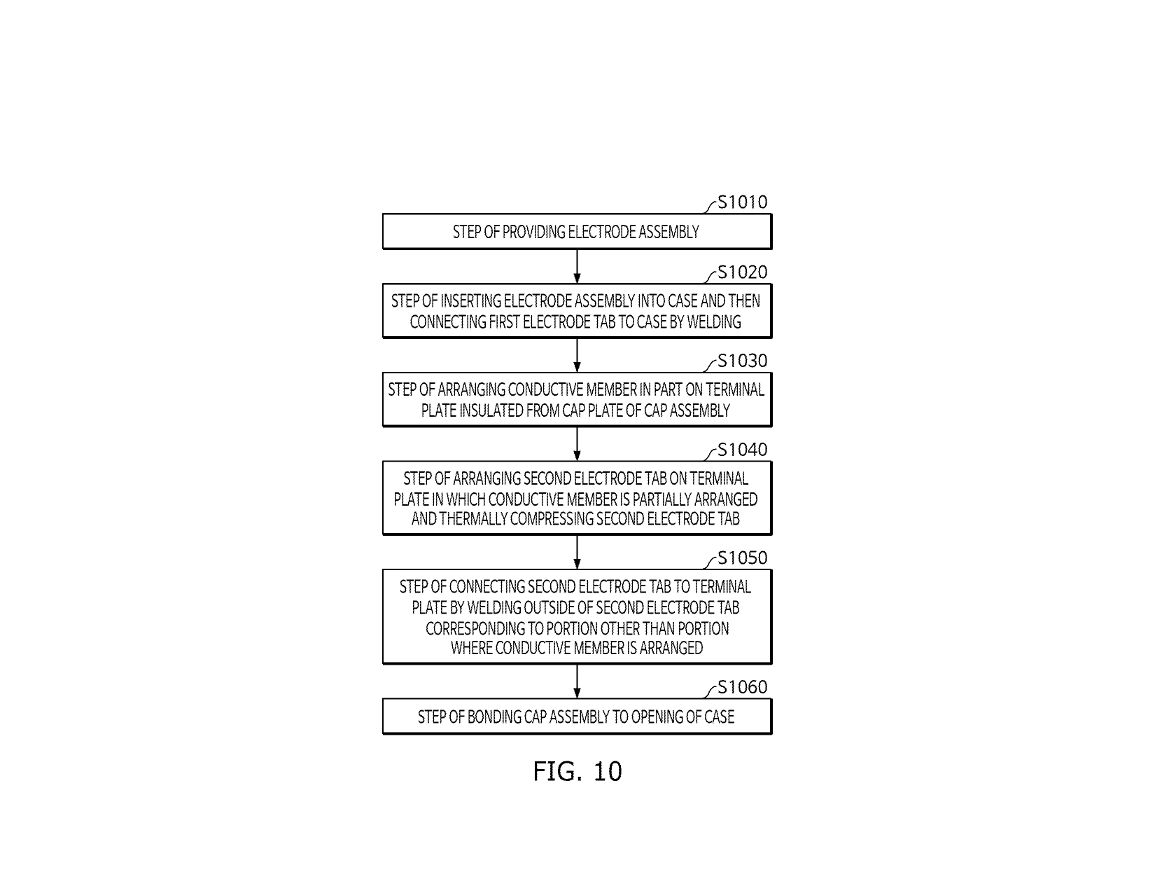

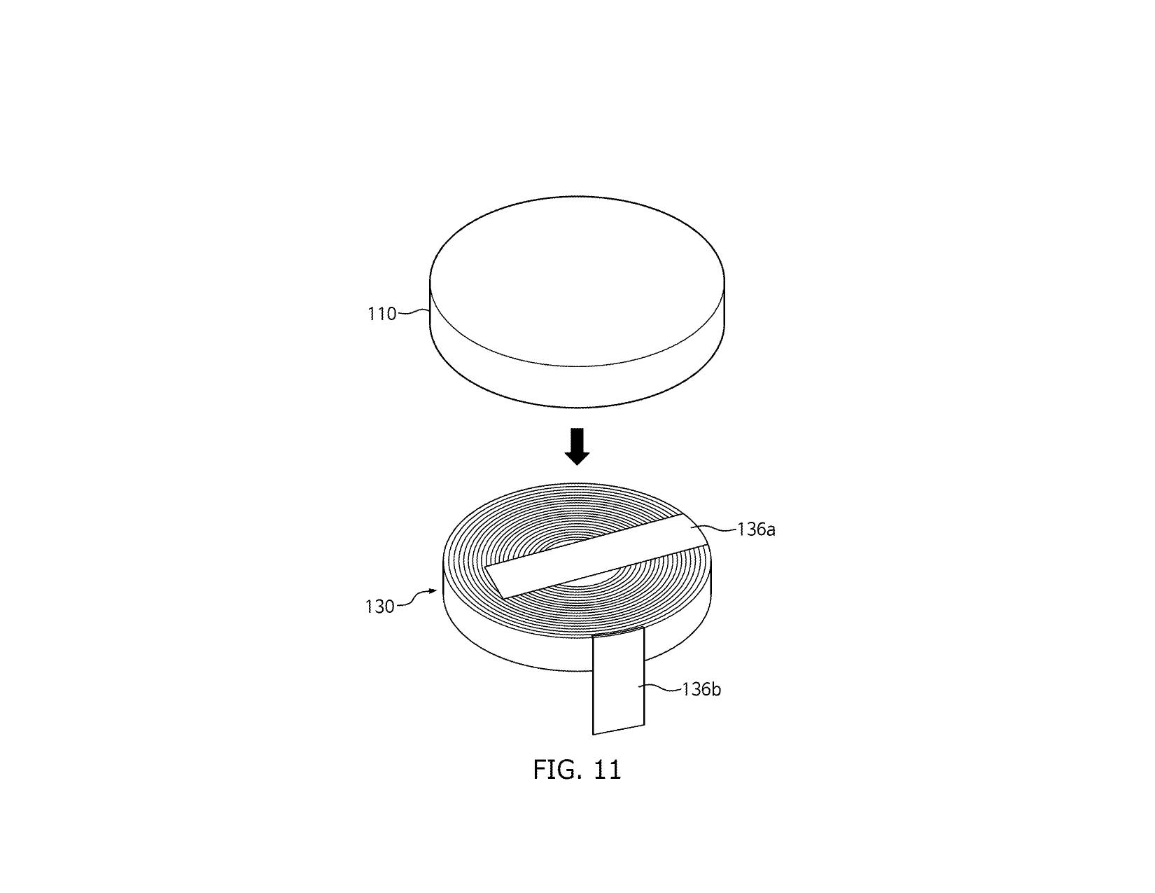

FIG. 10 is a flowchart for describing a battery manufacturing method according to one or more embodiments of the present disclosure. FIGS. 11 to 15 are diagrams for describing the battery manufacturing method according to one or more embodiments of the present disclosure. The descriptions overlapping with the above-mentioned contents are omitted.

The battery manufacturing method according to one or more embodiments of the present disclosure may include a step S1010 of providing the electrode assembly including the first electrode plate to which the first electrode tab is connected, the second electrode plate to which the second electrode tab is connected, and the separator interposed between the first electrode plate and the second electrode plate.

Subsequently, the battery manufacturing method according to one or more embodiments may include a step S1020 of inserting the electrode assembly 130 described above into the case and then connecting the first electrode tab to the case by welding. Referring to FIG. 11, before the electrode assembly 130 in which the first electrode tab 136a and the second electrode tab 136b are connected is inserted into the case 110, the first electrode tab 136a may be folded such that the first electrode tab 136a is arranged on the bottom surface of the case 110, and may be secured to the upper surface or the lower surface of the electrode assembly. The electrode assembly may be inserted into the case 110 such that the second electrode tab 136b protrudes toward the opening of the case 110.

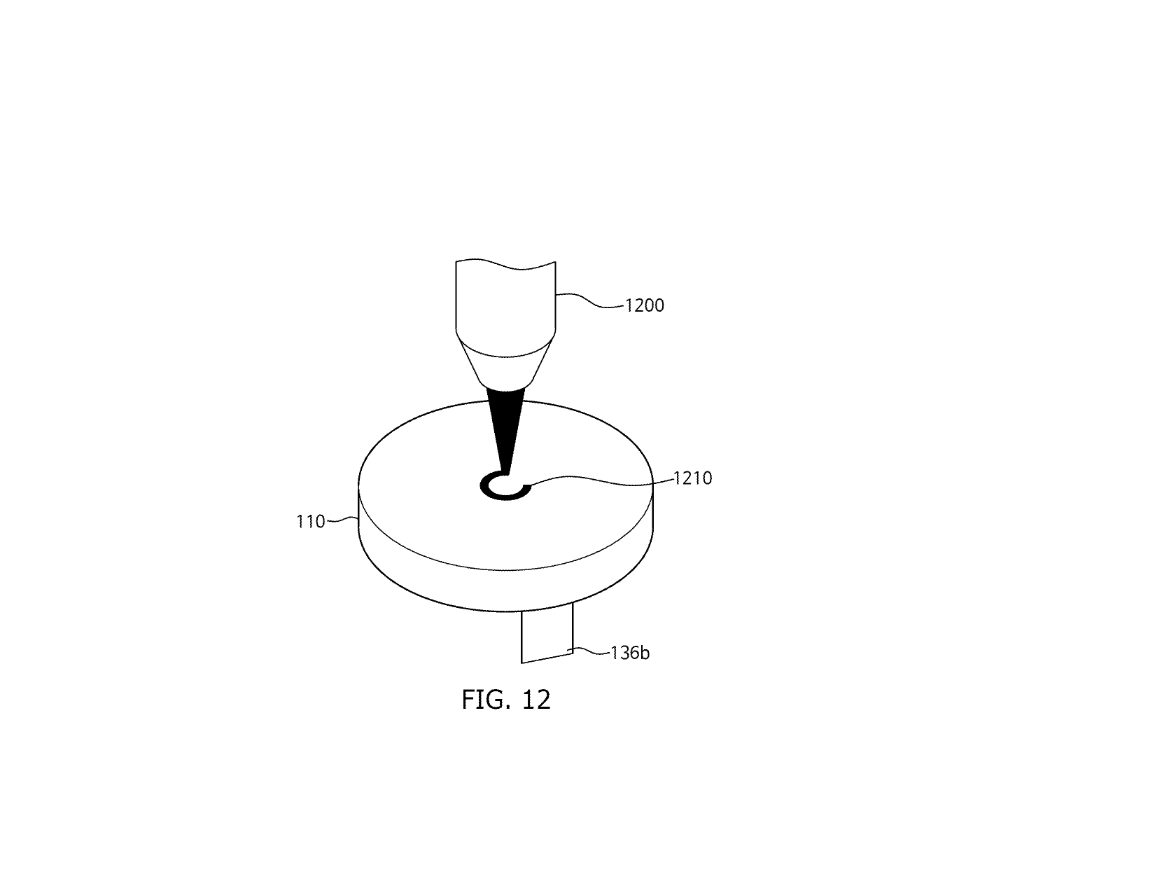

Referring to FIG. 12, when the first electrode tab 136a is connected to the case 110 by welding, the case and the first electrode tab (for example, 136a in FIG. 11) may be fixed by welding outside the case 110.

Subsequently, the battery manufacturing method according to one or more embodiments may include a step S1030 of arranging the conductive member in a part on the terminal plate insulated from the cap plate of the cap assembly.

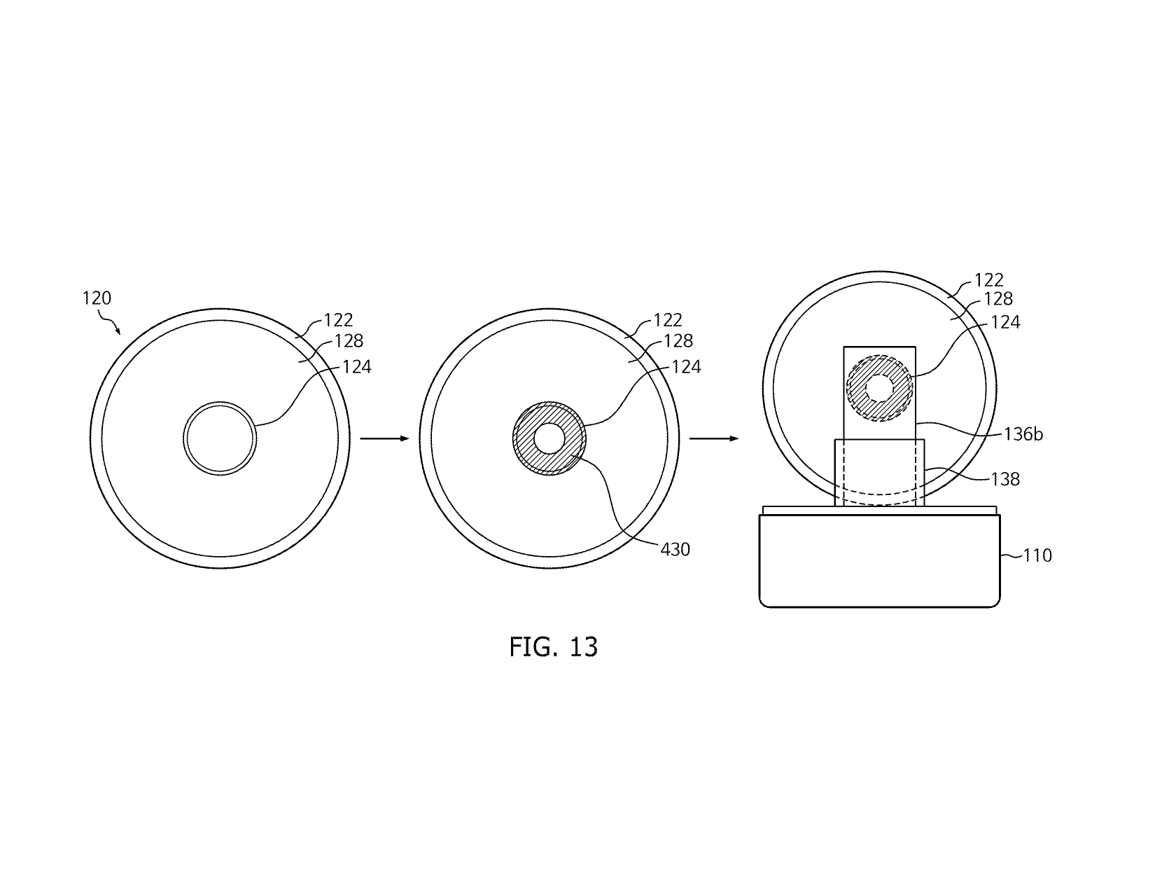

FIG. 13 is a diagram for describing a step of connecting the terminal plate 124 and the second electrode tab by thermocompression. In one or more embodiments, step S1030 of arranging the conductive member in a part on the terminal plate insulated from the cap plate 122 of the cap assembly may include a step of applying and drying, as the conductive member 430, the conductive paste described above in the part on the terminal plate 124. For example, a thickness of the paste may be set to about 20 μm or less in order to prevent the paste from coming off during thermocompression.

In one or more embodiments, step S1030 of arranging the conductive member in the part on the terminal plate insulated from the cap plate of the cap assembly may include a step of providing, as the conductive member 430, a conductive film having a size corresponding to the part on the terminal plate 124 and attaching the conductive film to the part on the terminal plate 124.

Referring to FIG. 13, first, the terminal plate 124 that may include the protrusion manufactured to penetrate through the central hole of the cap plate 122 and the flange bonded on the protrusion may be connected to the central hole of the cap plate 122. In one or more embodiments, the cap plate 122 and the terminal plate 124 may be insulated and fixedly bonded by arranging the insulating member 128 on the lower surface of the cap plate 122 and arranging the insulating layer between the flange and the cap plate 122. As illustrated in FIG. 13, the conductive member 430 may be arranged on the end surface of the protrusion arranged on the lower surface of the cap plate 122. Thereafter, the cap assembly may be bonded to the opening of the case 110 in which the previously prepared electrode assembly is accommodated.

Subsequently, the battery manufacturing method according to one or more embodiments may include a step S1040 of arranging the second electrode tab on the terminal plate in which the conductive member is partially arranged and thermally compressing the second electrode tab. A volume of the conductive member 430 arranged between the second electrode tab 136b and the terminal plate 124 can be partially reduced through thermocompression. A size of a region occupied by the conductive member 430 in the step of arranging the conductive member 430 and a size of a region occupied by the conductive member 430 after thermocompression may be different. For example, the size of the region occupied by the conductive member 430 after thermocompression may be larger.

In the thermocompression process according to one or more embodiments, thermocompression conditions may be a low temperature and a low pressure in order to prevent damage to the second electrode tab 136b. For example, thermocompression may be performed under a low temperature condition of about 150°C to 200°C and a low pressure condition of about 5 MPa.

Subsequently, the battery manufacturing method according to one or more embodiments may include a step S1050 of connecting the second electrode tab to the terminal plate by welding an outside of the second electrode tab corresponding to a portion other than the portion where the conductive member is arranged.

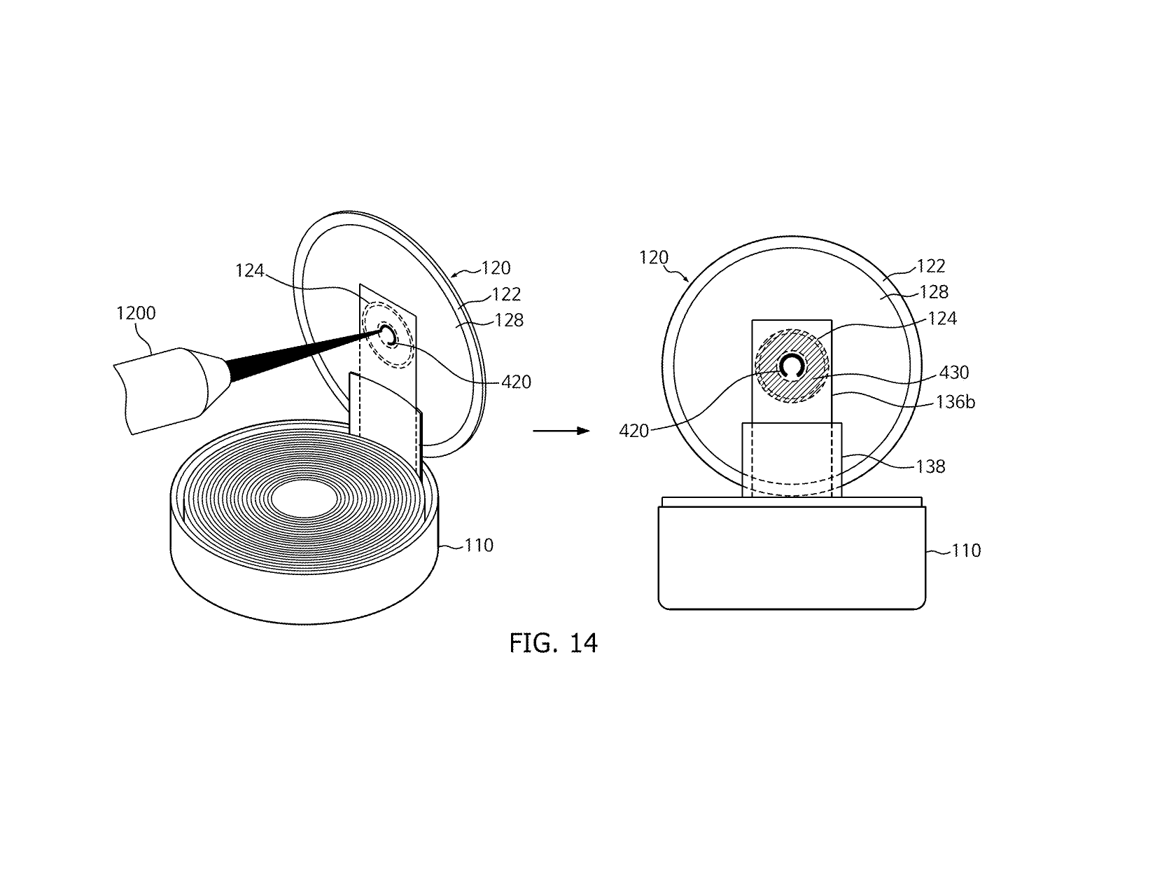

FIG. 14 is a diagram for describing the step of connecting the second electrode tab to the terminal plate by welding in FIG. 10. Referring to FIG. 14, the second electrode tab 136b and the terminal plate 124 may be fixedly bonded by welding the outside of the second electrode tab 136b corresponding to the portion other than the portion where the conductive member 430 is arranged.

Subsequently, the battery manufacturing method according to one or more embodiments may include a step S1060 of bonding the cap assembly to the opening of the case.

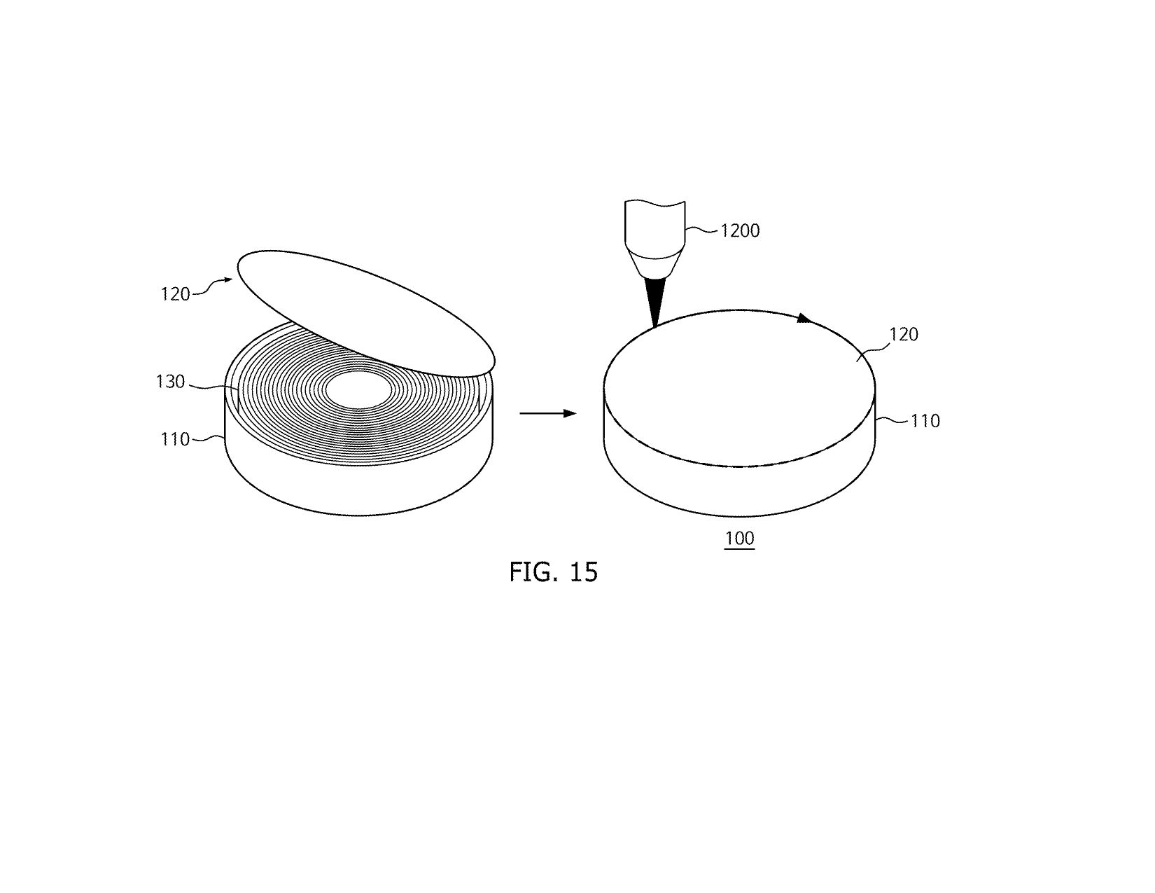

FIG. 15 is a diagram illustrating the step of attaching the cap assembly to the opening of the case in FIG. 10. In one or more embodiments, after the second electrode tab 136b is fixed, a step of injecting an electrolyte or the like and bonding the cap assembly to the opening of the case 110 may be performed.

The flow chart of FIG. 10 and the above description are merely examples of the present disclosure, and the scope of the present disclosure is not limited to the flow chart of FIG. 10 and the above description. For example, one or more steps in the flowchart and/or the above description may be added, changed, and deleted, the order of one or more steps may be changed, and one or more steps may be simultaneously performed.

According to some embodiments of the present disclosure, cracks can be prevented from occurring in the electrode tab or the electrode terminal in the connection portion between the electrode tab and the electrode terminal of the battery.

According to some embodiments of the present disclosure, the conductivity of the connection portion between the electrode tab and the electrode terminal of the battery can be enhanced.

According to some embodiments of the present disclosure, the adhesive strength between the electrode tab and the electrode terminal of the battery can be enhanced.

According to some embodiments of the present disclosure, the problem of the performance degradation due to the increased internal resistance of the battery can be solved.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims. Description of some reference symbols 100: battery 110: case 120: cap assembly 122: cap plate 124: terminal plate 124a: protrusion 124b: flange 126: insulating layer 128: insulating member 130: electrode assembly 132a: first electrode plate 132b: second electrode plate 134: separator 136a: first electrode tab 136b: second electrode tab 138: cover tape 140: sealing tape 142: insulating washier 400: first portion 410: second portion 420: welding portion 430: conducive member 440: central hole 1200: welding machine 1210: welding portion

What is claimed is:

1. A battery, comprising:
an electrode assembly including a first electrode plate to which a first electrode tab is connected, a second electrode plate to which a second electrode tab is connected, and a separator interposed between the first electrode plate and the second electrode plate;
a case accommodating the electrode assembly, the case being connected to the first electrode tab;
a cap assembly including a cap plate bonded to an opening of the case and a terminal plate insulated from the cap plate, the second electrode tab contacting and being connected to a first portion of the terminal plate facing the electrode assembly; and
a conductive member in a second portion of the terminal plate different from the first portion.

2. The battery as claimed in claim 1, wherein:
the terminal plate includes a tab connection surface connected to the second electrode tab, and a shape of the tab connection surface is circular or polygonal.

3. The battery as claimed in claim 2, wherein:
the first portion is a central region of the tab connection surface, and the second portion is an outer region of the tab connection surface.

4. The battery as claimed in claim 2, wherein:
the first portion is an outer region of the tab connection surface, and the second portion is a central region of the tab connection surface.

5. The battery as claimed in claim 1, wherein the conductive member is an isotropic conductive adhesive or an anisotropic conductive adhesive.

6. The battery as claimed in claim 1, wherein the conductive member is a conductive film having an adhesive material on at least one surface.

7. The battery as claimed in claim 1, wherein the conductive member is a conductive paste.

8. The battery as claimed in claim 1, wherein the battery is a coin battery or a button battery.

9. The battery as claimed in claim 1, wherein the terminal plate includes a protrusion inserted into a central hole of the cap plate and a flange connected to an upper portion or a lower portion of the protrusion.

10. The battery as claimed in claim 9, wherein the protrusion faces the electrode assembly.

11. The battery as claimed in claim 10, wherein a size of the second electrode tab is larger than a size of an end surface of the protrusion to which the second electrode tab is connected.

12. The battery as claimed in claim 11, wherein:
the first portion is a central region of an end surface of the protrusion, and the second portion is an outer region of the end surface of the protrusion.

13. The battery as claimed in claim 11, wherein:
the first portion is an outer region of the end surface of the protrusion, and the second portion is a central region of the end surface of the protrusion.

14. The battery as claimed in claim 10, wherein a size of the second electrode tab is smaller than a size of an end surface of the protrusion to which the second electrode tab is connected.

15. The battery as claimed in claim 14, wherein:
the first portion is a central region of a surface of the end surface of the protrusion corresponding to the second electrode tab, and the second portion is an outer region of the surface of the end surface of the protrusion corresponding to the second electrode tab.

16. The battery as claimed in claim 14, wherein:
the first portion is an outer region of a surface of the end surface of the protrusion corresponding to the second electrode tab, and the second portion is a central region of the end surface of the protrusion corresponding to the second electrode tab.

17. A battery manufacturing method, comprising:
providing an electrode assembly including a first electrode plate to which a first electrode tab is connected, a second electrode plate to which a second electrode tab is connected, and a separator interposed between the first electrode plate and the second electrode plate;
inserting the electrode assembly into a case and then connecting the first electrode tab to the case by welding; arranging a conductive member in a part on a terminal plate insulated from a cap plate of a cap assembly;
arranging the second electrode tab on the terminal plate in which the conductive member is partially arranged and thermally compressing the second electrode tab;
connecting the second electrode tab to the terminal plate by welding an outside of the second electrode tab corresponding to a portion other than a portion where the conductive member is arranged; and
bonding the cap assembly to an opening of the case.

18. The battery manufacturing method as claimed in claim 17, wherein the arranging of the conductive member in the part on the terminal plate insulated from the cap plate of the cap assembly includes applying a conductive paste as the conductive member to the part on the terminal plate and drying the conductive paste.

19. The battery manufacturing method as claimed in claim 17, wherein the arranging of the conductive member in the part on the terminal plate insulated from the cap plate of the cap assembly includes providing, as the conductive member, a conductive film having a size corresponding to the part on the terminal plate, and attaching the conductive film to the part on the terminal plate.

20. The battery manufacturing method as claimed in claim 17, wherein the conductive member is an isotropic conductive member or an anisotropic conductive member.
